(19) United States
(12) Patent Application Publication
(10) Pub. No.: US 2003/0208936 A1
(43) Pub. Date: Nov. 13, 2003

(54) Method for manufacturing embroidery decorated cards and envelopes

(76) Inventor: Charles Hee Lee, Hacienda Hts, CA (US)

Correspondence Address: Eugene OAK, Ph. D., Patent Attorney, 610 S. Van Ness Ave., Los Angeles, CA, 90005, US

(21) Appl. No.: 10/086,800

(22) Filed: May 9, 2002

(51) Int. Cl. G09F 1/00; A47G 1/06

(52) U.S. Cl. 40/124.06; 40/765; 229/92.8

(57) ABSTRACT

A method for manufacturing cards and envelops decorated with embroidered fabrics is provided. Various kinds of drawings are embroidered on a fabric with threads of different colors. Firstly, a paper is cut into the shape of this invention. The first sheet of card stock is folded into four portions. A part of the first portion of the card stock, the frame, is cut out of various shapes such as heart, square, and star. The embroidered fabric is cut into a certain size and adhered to the rear side of the frame, on which peel off glue is attached, without applying any heat or pressure. The front side of the paper frame is decorated with, including but not limited to, various kinds of paintings, pictures, phrases and emblems. The card of this invention may be used as, including but not limited to, a season's greeting card, a congratulatory card, a business card, an invitatory card, a post card, and an envelop for previously recommended cards.

This invention relates to an economical method for manufacturing cards and envelopes decorated with embroidered fabrics.

1. Field of the Invention

A method for manufacturing cards and envelopes decorated with embroidered fabrics is provided. Various kinds of embroidered fabrics are cut into certain size and patched behind a paper frame to make, including but not limited to, a seasonal greeting card, congratulatory card, a business card, an invitation card, a post card and an envelope.

2. Description of the Prior Art

U.S. Pat. No. 4,439,941 to Halperine illustrates a printed card, tag and the like with a reusable printed multicolored emblem. A multicolored embroidered emblem is releasably attached to the face of a sheet printed with a design and provided with a surface with a reduced adhesive bonding. The multicolored embroidered emblem is constructed of embroidery made of a single white thread to form a sculptured pattern. The sculptured pattern is created by varying the direction of the stitches of the embroidery thread and the number of thread stitches in various locations of the embroidered emblem. The multicolored pattern is printed on the face with at least two colors of dye stuff by a sublimation printing process, wherein the dyestuff is transferred in a vapor state under heat and pressure or vacuum. The dyestuff, which forms the printing on the embroidery threads, forms the layer.

U.S. Pat. No. 5,727,490 to McGaver teaches a method of manufacturing a greeting card. The process consists of folding a first sheet of card stock into a tri-fold configuration having first to third equal portions, cutting a window into the first portion, and bonding the first portion, the second portion, and the sheet of fabric, consecutively. A sheet of embroidery decorated fabric is disposed between the first and second sections of card stock. A sheet of poly- ester polymer web adhesive, having a minimum heat activation temperature of 280° F. and a density 0.3 lbs per gallon, is disposed between the sheet of fabric and the second section of card stock to bond the sheet of fabric to the first and second sections of card stock, by applying heat at a temperature range of 300 to 310° F. and a pressure range of 240 to 260 lbs per square inch.

Those prior arts have very sophisticated and energy consuming procedures.

### SUMMARY OF THE INVENTION

Therefore, it is the purpose of this invention to provide a method for manufacturing cards and envelopes decorated with embroidered fabrics at a reduced cost and energy. Various kinds of drawings are embroidered on a fabric with threads of different colors. Firstly, a paper is cut into the shape of this invention. The first sheet of card stock is folded into four portions. A part of the first portion of the card stock is cut out of various shapes such as heart, square, and star. to make a frame. The embroidered fabric is cut into certain size and adhered to the rear side of the frame, on which peel off glue is attached, without applying heat and pressure. Front side of the paper frame is decorated with, including but not limited to, various kinds of the paintings, pictures, phrases and emblems. The card of this invention may be used as, including but not limited to, a season's greeting card, congratulatory card, a business card, an invitatory card, a post card, and envelopes for previously recommended cards.

### BRIEF DESCRIPTION OF THE DRAWINGS

FIG. 1 is a front view of the first sheet of card stock of this invention before folding.

FIG. 2 is a rear view of the first sheet of card stock of this invention before folding.

FIG. 3 is a schematic configuration of frame layer, peel off glue, embroidery, second portion of the card stock.

FIG. 4 is an outer surface view of the card of this invention after completion.

FIG. 5 is an inner surface view of the card of this invention after completion.

FIG. 6 is a front view of the first sheet of postcard stock of this invention prior to folding.

FIG. 7 is a schematic configuration of frame layer, tape, embroidery, second portion of the postcard stock.

FIG. 8-a is a front view (8-a) of the postcard completed.

FIG. 8-b is a rear view (8-b) of the postcard completed.

FIG. 9 is a front view of the first sheet of envelops stock of this invention.

FIG. 10 is a perspective view of the envelope completed.

### DETAILED DESCRIPTION OF THE PREFERRED EMBODIMENTS

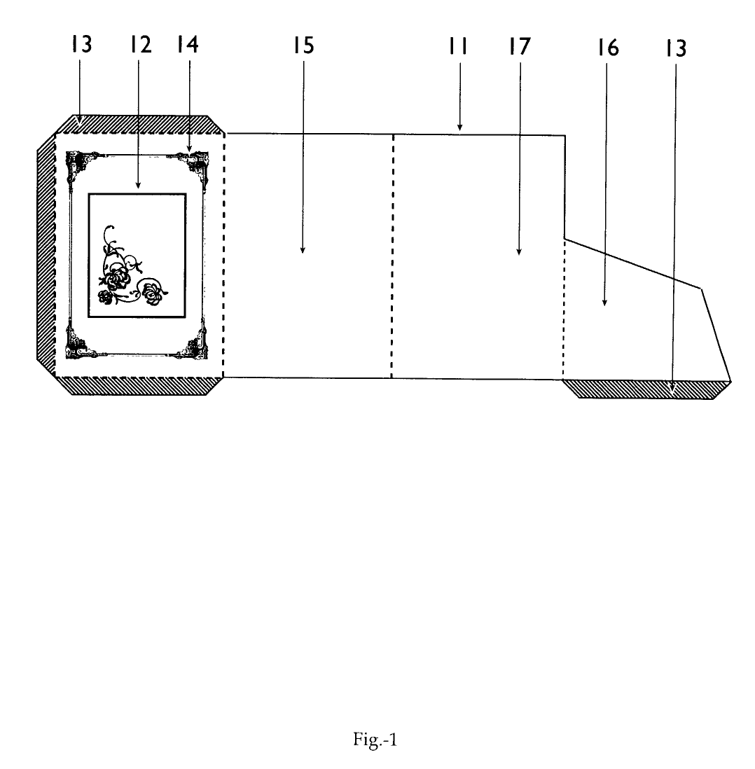

A first sheet of card stock is cut into a form shown as (11) in FIG. 1. A window (12) of various shapes is punctured on the first portion of the card stock (14). Peel off glue is adhered on the face of the wings of (13). Three wings (13) on the first portion of the card stock (14) are folded backward to be bonded to the rear face of the second portion of the card stock (15). One of the wings (13) on the fourth portion of the card stock (16) is folded backward and bonded to the third portion of the card stock (17). Lower border lengths of the first three portions are the same. The border length of the forth portion of the card (16) is a little bit shorter.

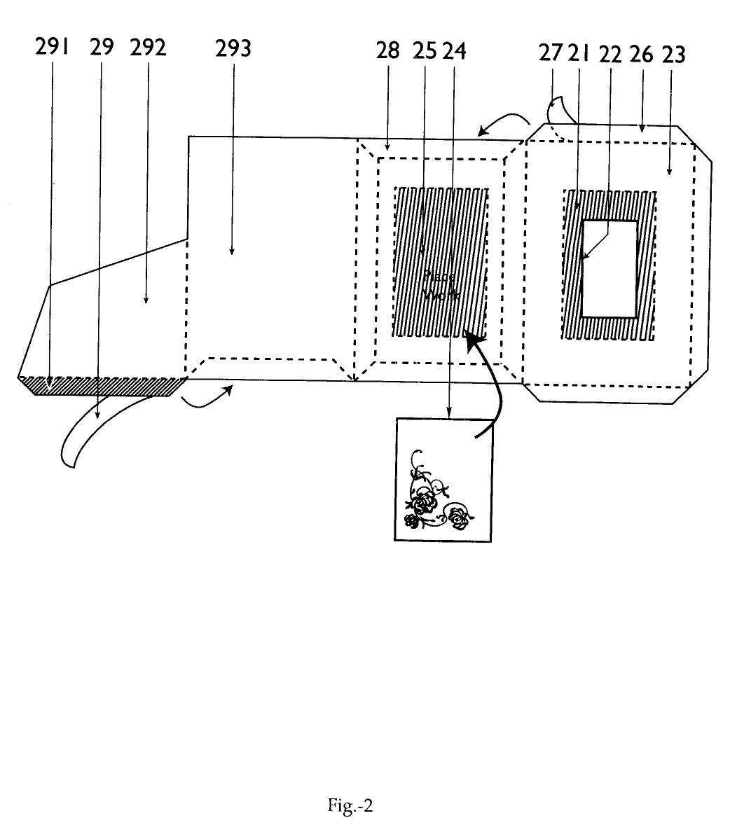

FIG. 2 is the rear view of the card stock. Peel off glue having window in the middle (21) is adhered on the rear face surrounding the window (22) punctured on the first portion of the card stock (23). Embroidery decorated fabric (24), cut into certain size, is positioned after the film protecting the glue on the place mark (25) is peeled off. The wings (26) on the first portion of the card stock (23), on which the peel off glues are adhered, are folded inwards. The peels (27) are removed and the wing is bonded on to the front face of the second portion of the card stock (28). At the same time, the peel (29) on the wing (291) of the fourth portion of the card stock (292) is removed and the wing (291) is bonded to the third portion of the card stock (293).

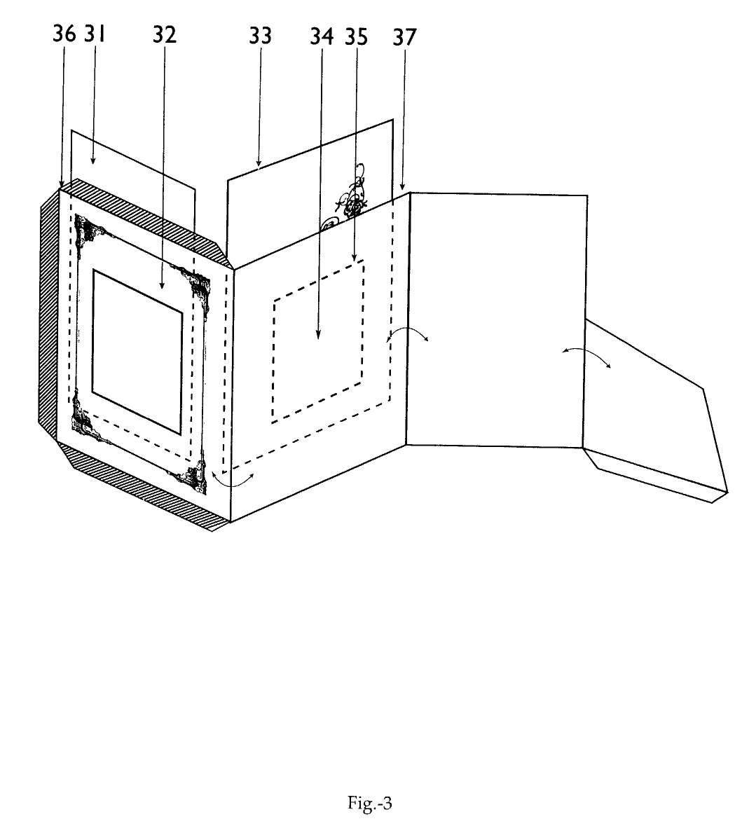

FIG. 3 is a schematic configuration of frame layer, tape, embroidery, and the second portion of the card stock. Peel off glue (31) having a window in the middle is attached at the rear face of the frame layer (32). Embroidery decorated fabric (33) locates on the mark place (34) over which the peel off glue (35) is attached. The first portion of the card stock (36) is folded over the second portion of the card stock (37).

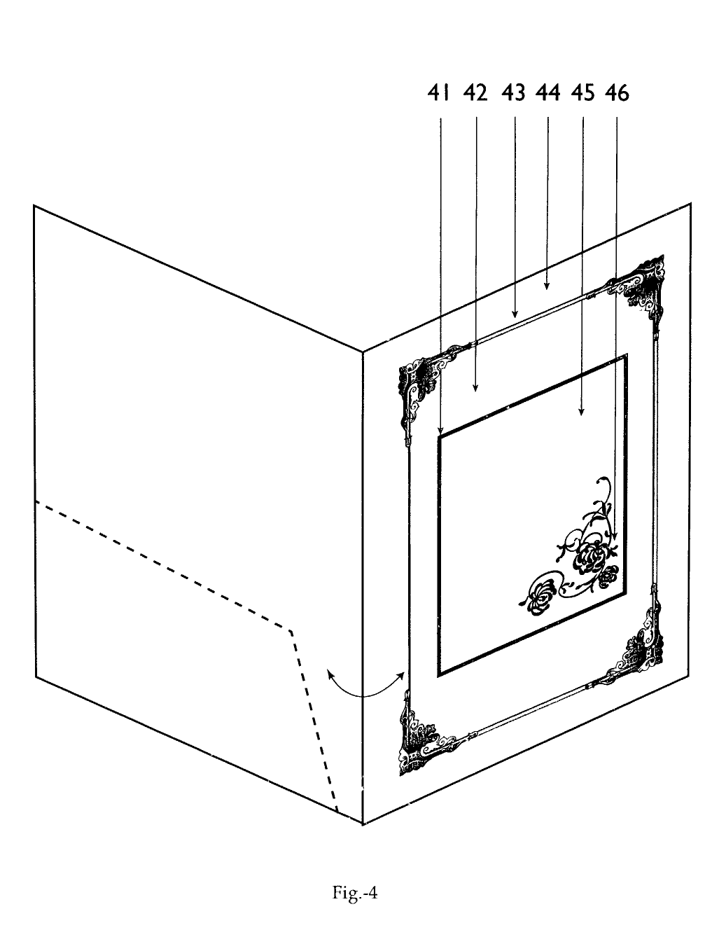

Slight pressing the folded card stock with hand results a card as FIG. 4. The front face of the greeting card has a window (41) of various shape such as square, heart and star. The frame (42) of the face is decorated with, including but not limited to, a printing, embroidery, phrases and embossing (43). Behind the first part of the card stock (44), locates a fabric (45) consisting of, including but not limited to, a velvet, cotton, polyester, nylon and wool. The fabric (45) is decorated with embroidery (46) of various designs. Using threads of different colors controls the color of the embroidery.

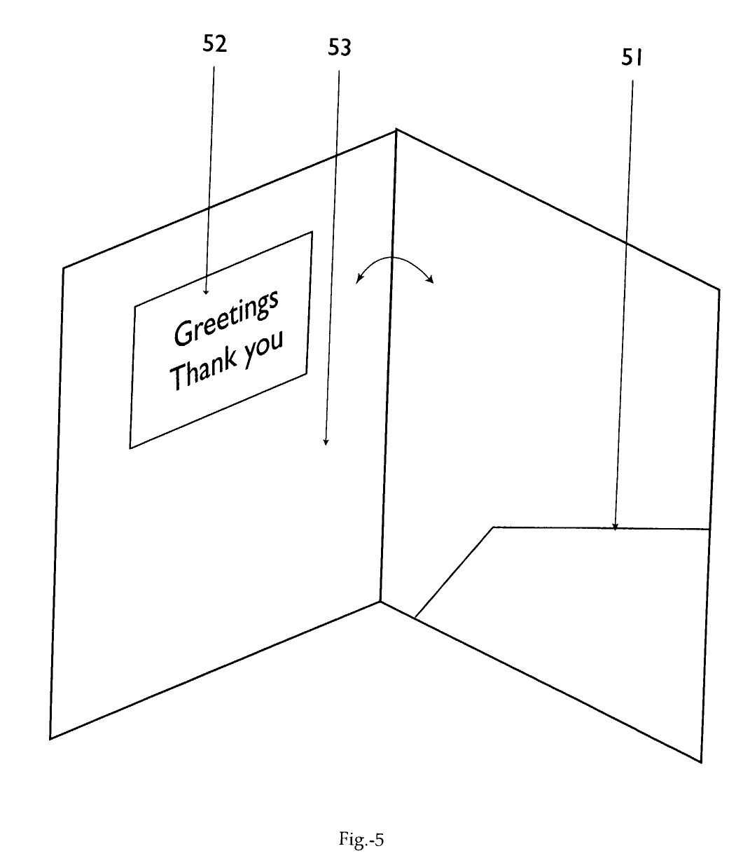

FIG. 5 is an inner surface view of the card of this invention after completion. The small fourth part of the card stock, (292) of the FIG. 2, becomes pocket (51) for some messages, if desired. Greeting messages (52) can be printed on the inner side of the third part of the card stock (53).

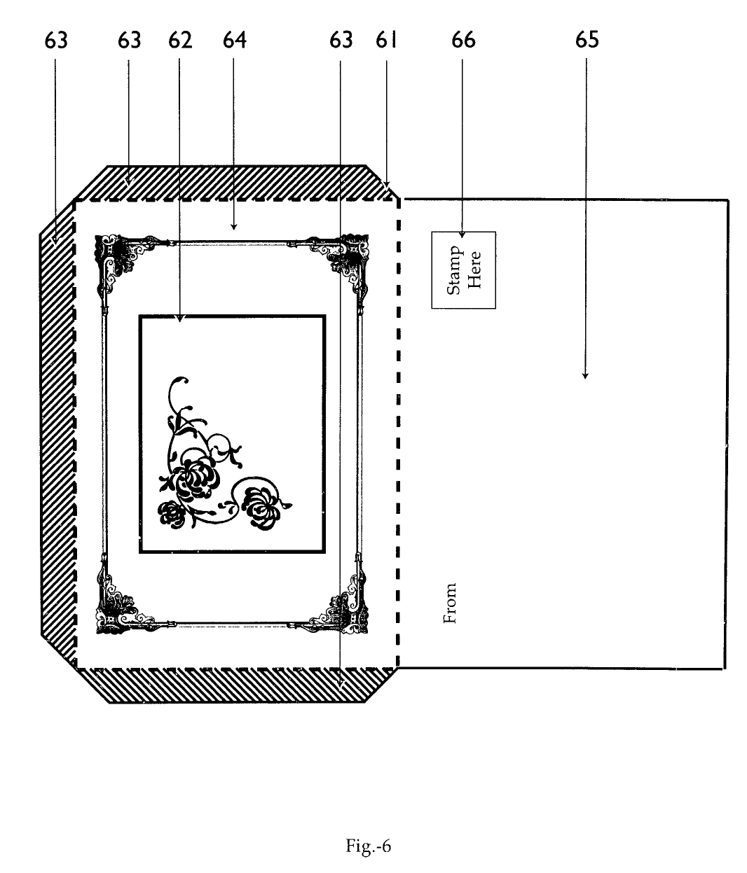

FIG. 6 is a front view of the first sheet of postcard stock of this invention prior to the folding. A first sheet of card stock is cut into a form shown as (61). A window (62) of various shapes is punctured on the first portion of the postcard stock (64). Peel off glues are adhered on the face of the wings (63). Three wings (63) on the first portion of the postcard stock (64) are folded backwards to be bonded to the rear face of the second portion of the postcard stock (65). Lower border lengths of the two portions are the same. Stamp positions (66) and necessary messages are printed on the second part of the postcard stock (65).

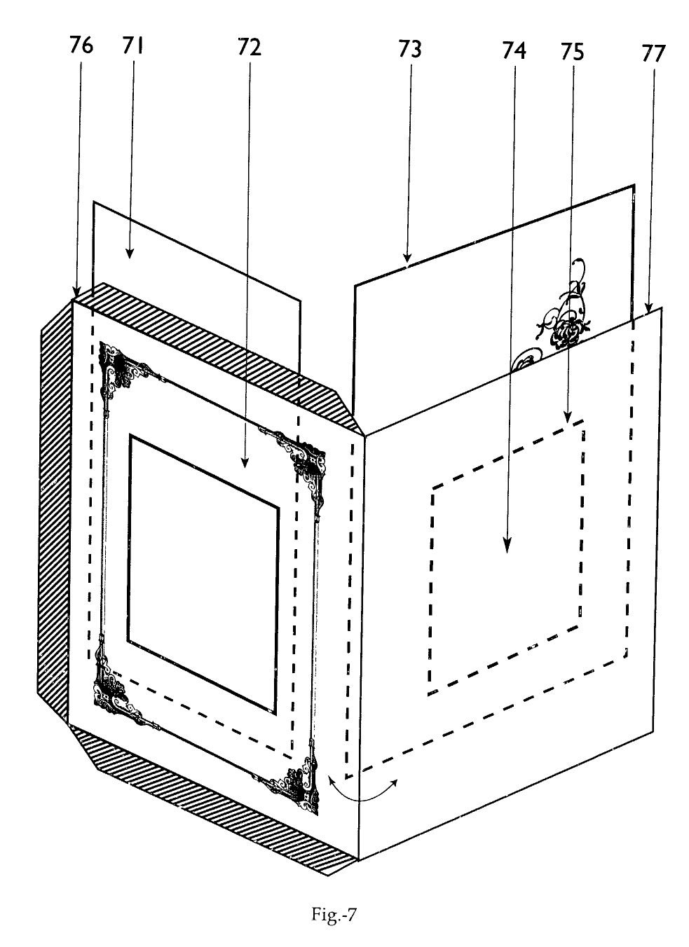

FIG. 7 is a schematic configuration of frame layer, tape, embroidery, second portion of the postcard stock. The peel off glue having window in the middle (71) is attached at the rear face of the frame layer (72). Embroidery decorated fabric (73) locates on the mark place (74) over which the peel off glue (75) is attached. The first portion of the card stock (76) is folded over the second portion of the card stock (77). Slightly pressing of the folded postcard stock with hand result in a desired postcard.

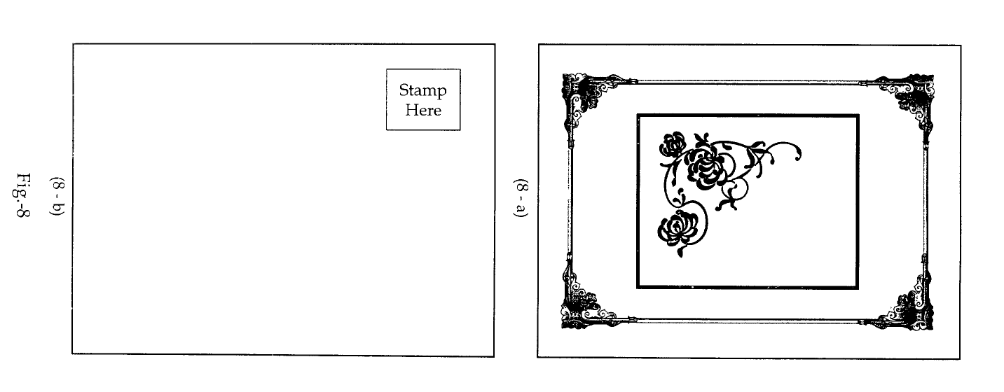

FIG. 8 is a front view (8-a) and rear view (8-b) of the postcard completed.

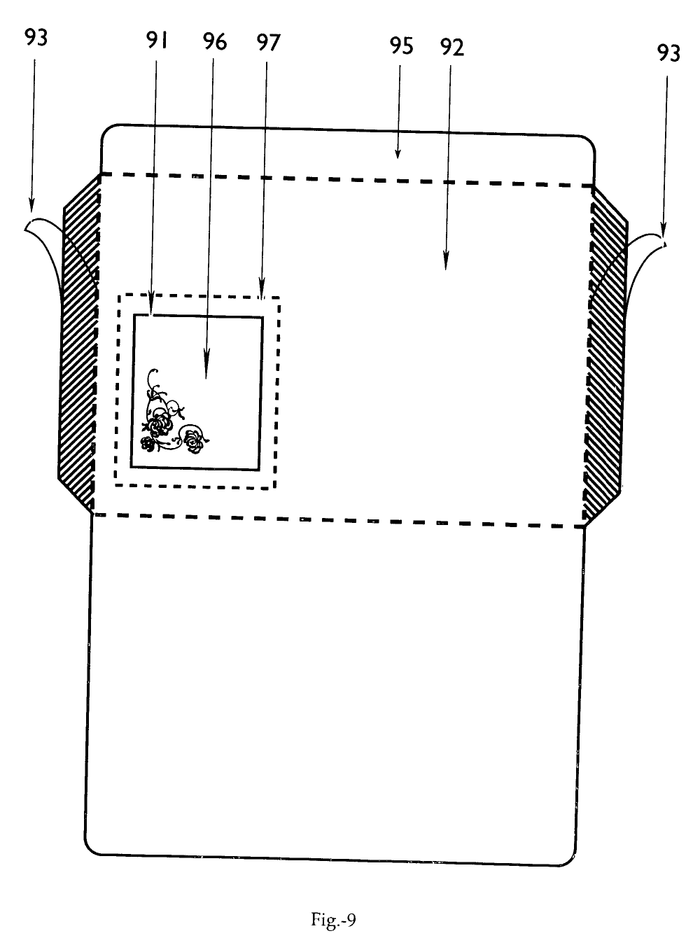

FIG. 9 is a front view of the first sheet of envelops stock of this invention. Small window (91) is punched at the comer of the first part of the envelope stock (92). The peel off glues (93) are adhered on the two wings (94), which are located on the apposite site of the first stock of the first part of the envelope stock (92). The wing (95) in the middle has no glue on it. Embroidery decorated fabric (96) is attached behind the window (91) by the peel off glue (97) adhered on the rear side of the window (91).

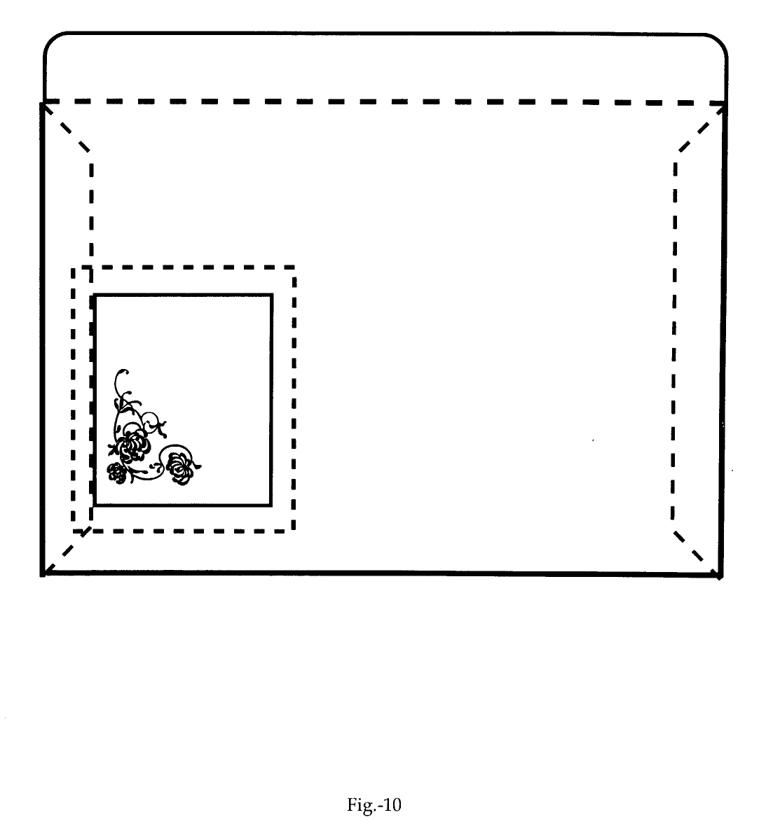

FIG. 10 is a perspective view of the envelope completed.

What is claimed is;

1. A method for manufacturing cards and envelopes decorated with embroidered fabrics on the first part of the evenly divided first sheet of the card, post card and envelope.

2. The first sheet of card stock in claim 1 is divided into four portions for greeting cards and the first portion of the card stock punctured out as various shapes of heart, square, and star.

3. The first sheet of post card and envelope stock in claim 1 is divided into two portions and the first portion of the card stock punctured out as various shapes of heart, square, and star.

4. The embroidered fabric in claim 1 is cut into certain sizes and adhered to the rear side of the first portion, on which peel off glue is attached, without applying any heat and pressure.
